(19) United States
(12) Patent Application Publication
(10) Pub. No.: US 2023/0032089 A1
(43) Pub. Date: Feb. 2, 2023

(54) SYSTEM AND METHOD FOR STORAGE AND COMMUNICATION OF ON-BOARD COMMERCIAL VEHICLE DATA

(71) Applicant: 11598775 CANADA INC., Pointe-Claire, Québec (CA)

(72) Inventors: Éric Garzon, Pointe-Claire, Québec (CA); Réal Barrière, Bourget, Ontario (CA)

(73) Assignee: 11598775 CANADA INC., Pointe-Claire, Québec (CA)

(21) Appl. No.: 17/794,021

(22) PCT Filed: Jan. 20, 2021
(86) PCT No.: PCT/CA2021/050058

§ 371 Date: Jul. 20, 2022

Related U.S. Application Data
(60) Provisional application No. 62/963,370, filed on Jan. 20, 2020.

(51) Int. Cl. H04B 10/114; H04W 4/44

(52) U.S. Cl. CPC H04B 10/1149; H04W 4/44

(57) ABSTRACT

A system for storage and communication of on-board data generated on-board a movable commercial vehicle including an embarked system generating the on-board data; an on-board data communication network; and a mobile data storage and exchange unit installed on the movable commercial vehicle and in data communication with the embarked system through the on-board data communication network. The mobile data storage and exchange unit comprises: a mobile storage unit for storing the on-board commercial vehicle data received and stored at a data input speed limited by a network speed of the on-board data communication network; and a wireless communication module allowing data transfer between the mobile data storage and exchange unit and a ground data storage and exchange unit and having a data transfer speed greater than the data input speed.

### TECHNICAL FIELD OF THE INVENTION

The present invention relates to the field of data storage and communication. More particularly, it relates to a system and a method for acquisition and storage of data at conventional network speed and communication of data generated on-board of mobile commercial vehicles to a ground infrastructure, using a high throughput communication technology. The system and method can therefore allow a large quantity of data to be transferred during a limited time periods where each corresponding mobile commercial vehicle is physically positioned to enable data communication between the vehicle and a fixed communication terminal.

### BACKGROUND

Commercial vehicles such as, for example and without being limitative, transit buses, railcars, etc., are equipped with multiple embarked electronic systems collecting and storing data while the vehicle is in operation. The data generated on-board can include any type of data the vehicle can be configured to collect, such as, for example and without being limitative, system health and diagnostic data, positioning data, passenger information data, fare collection data, telemetry data, automatic passenger counting data, media and entertainment data, video surveillance data, etc. In view of the above, one skilled in the art will understand that a substantial quantity of data (e.g. a quantity sometimes exceeding 100 GB/day) can be generated by each vehicle.

One of the challenges associated with such a volume of data being generated is that, in order to be most relevant, a large quantity of the generated on-board data must be processed and analyzed (for example and without being limitative through AI analysis) using a computer having high computing power. However, the computers having the necessary computing power to interpret and analyze the quantity of generated on-board data generally cannot be installed on-board the vehicles. Hence, the large volume of on-board generated data should be transmitted from the vehicle to a fixed computing infrastructure located on the ground. Such transmission must be performed in a timely and secure manner in order to ensure data privacy and make the most recent data available to the fixed computing infrastructure, without undue time delay. Conversely, the on-board systems and sensors of the vehicles also occasionally need upgrades and maintenance updates, thereby requiring data to be uploaded from the fixed computing infrastructure, to the vehicles to perform such upgrades or updates.

Currently, the known methods and systems used to transfer data in batch between the vehicles and the fixed computing infrastructure require either wireless transmission technologies such as Wi-Fi access points, or the like, at the sites where the vehicles are immobilized for time periods (e.g. yards, depots, terminals, etc.), a cellular network connection, or a manual intervention by a user accessing the vehicle to physically interact with the on-board system, for example to connect a portable storage device to the vehicle, connect a physical communication wire, etc. and download the data thereto for subsequent upload to the fixed computing infrastructure.

Such known methods and systems to perform the transfer of data between the commercial vehicle and the fixed computing infrastructure suffer from several drawbacks such as saturation of the RF bands, cost of wireless connections, data security and/or availability of the vehicles to perform the transfer. Indeed, the known methods and systems often offer data transfer speeds which are insufficient to transfer all of the substantial volume of data between the commercial vehicle and the fixed computing infrastructure, during the limited time periods where the vehicles remain at the sites where they are within the data communication range in which data transfer can be performed. In cases where cellular network connections are used, it can be costly to transfer large quantity of data over such networks. In cases where manual intervention is required, it requires additional manpower and can lead to human mistakes, such as loss of portable storage devices, user forgetting to perform the manual data transfer, etc.

Such drawbacks often negatively impact the availability (i.e. accessibility to the data), timeliness (i.e. access to the most recent data) and quality (i.e. data being complete and accurate) of the data stored at the fixed computing infrastructure, which in turn negatively impacts the quality of the analysis and decision-making relying on this data. In order to improve the availability, timeliness and/or quality of the data stored at the fixed computing infrastructure, the system and method should therefore provide enhanced connectivity, data transfer speed and security/integrity of the data between the commercial transport vehicles and the fixed computing infrastructure.

In view of the above, there is a need for an improved system and method for storage and communication of on-board commercial vehicle data which, by virtue of its design and components, would be able to overcome or at least minimize some of the above-discussed prior art concerns.

### SUMMARY OF THE INVENTION

In accordance with a first general aspect, there is provided a system for storage and communication of on-board commercial vehicle data generated on-board a movable commercial vehicle The system comprises: at least one embarked system installed on the commercial vehicle and generating the on-board commercial vehicle data; an on-board data communication network; and a mobile data storage and exchange unit installed on the movable commercial vehicle and being in data communication with the at least one embarked system via the on-board data communication network of the movable commercial vehicle, to receive the on-board commercial vehicle data generated by the at least one embarked system. The mobile data storage and exchange unit comprises: a mobile storage unit for storing the on-board commercial vehicle data, the on-board commercial vehicle data being received and stored at a data input speed limited by a network speed of the on-board data communication network; and a wireless communication module allowing data transfer between the mobile data storage and exchange unit and a ground data storage and exchange unit, the wireless communication module having a data transfer speed greater than the data input speed and providing a high throughput data communication to perform batch transfer of the on-board commercial vehicle data stored on the mobile data storage and exchange unit to the ground data storage and exchange unit when the mobile data storage and exchange unit and the ground data storage and exchange unit are within a communication range.

In an embodiment, the maximal data input speed is about 100 Mbps.

In an embodiment, the minimal data transfer speed of the wireless communication module is about 1 Gbps.

In an embodiment, the wireless communication module comprises an optical wireless communication system comprising: at least one on-board optical transceiver included in the mobile data storage and exchange unit; and at least one ground optical transceiver included in the mobile data storage and exchange unit and optically connectable to the on-board optical transceiver to allow optical data transfer of the on-board commercial vehicle data between the mobile data storage and exchange unit and the ground data storage and exchange unit.

In an embodiment, the wireless communication module comprises: a plurality of on-board optical transceivers included in the mobile data storage and exchange unit; and a plurality of ground optical transceivers included in the mobile data storage and exchange unit and each being optically connectable to a corresponding one of the on-board optical transceivers to allow optical data transfer, each combination of on-board optical transceiver and ground optical transceiver operating at a specific wavelength being different for each combination.

In an embodiment, each on-board optical transceiver and each ground optical transceiver includes a signal processor, an optical transmitter and an optical receiver together defining a single optical stream.

In an embodiment, the system further comprises: a ground data repository; a ground data communication network; and the ground data storage and exchange unit being in data communication with the ground data repository via the ground data communication network, to allow data transfer of the on-board commercial vehicle data received by the ground data storage and exchange unit to the ground data repository.

In an embodiment, the system further comprises a vehicle virtual image generated and stored in the ground data repository, the vehicle virtual image being a data-mirror-image of the entirety of the on-board commercial vehicle data generated by the commercial vehicle.

In an embodiment, the mobile storage unit is configured to receive and store the on-board commercial vehicle data until a threshold quantity of on-board commercial vehicle data relative to a cluster category is reached and to generate a cluster of on-board commercial vehicle data relative to the corresponding cluster category, once the threshold quantity of data relative to the corresponding cluster category has been received, the cluster of on-board commercial vehicle data being stored in the mobile storage unit of the mobile data storage and exchange unit.

In an embodiment, the mobile storage unit is partitioned into a temporary storage partition storing the on-board commercial vehicle data until the threshold quantity of data relative to the cluster category is reached and a cluster storage partition storing the generated cluster of on-board data.

In accordance with another general aspect, there is also provided a system for storage and communication of on-board commercial vehicle data between a movable commercial vehicle and a ground data repository. The system comprises: at least one embarked system installed on the commercial vehicle and generating the on-board commercial vehicle data; an on-board data communication network; a ground data communication network; a mobile data storage and exchange unit having a mobile storage unit for storing on-board commercial vehicle data, the mobile data storage and exchange unit being installed on the movable commercial vehicle and being in data communication with the at least one embarked system via the on-board data communication network of the movable commercial vehicle to receive and store the on-board commercial vehicle data generated by the at least one embarked system on the mobile storage unit, the on-board commercial vehicle data being received and stored at a data input speed limited by a network speed of the on-board data communication network; and a ground data storage and exchange unit in data communication with the ground data repository via the ground data communication network, the ground data storage and exchange unit having a ground storage unit and being communicatively connectable to the mobile data storage and exchange unit to allow data transfer between the mobile data storage and exchange unit and a ground data storage and exchange unit, the ground data storage and exchange unit and the mobile data storage and exchange unit being configured to perform data transfer therebetween at a data transfer speed greater than the data input speed to perform batch transfer of the on-board commercial vehicle data stored on the mobile data storage and exchange unit to the ground data storage and exchange unit when the mobile data storage and exchange unit and the ground data storage and exchange unit are within a communication distance.

In an embodiment the maximal data input speed is about 100 Mbps.

In an embodiment, the minimal data transfer speed of the wireless communication module is about 1 Gbps.

In an embodiment, the mobile data storage and exchange unit comprises a mobile communication module including an on-board optical transceiver and the ground data storage and exchange unit comprises a ground communication module including a ground optical transceiver, the on-board optical transceiver being optically connectable to the ground optical transceiver for optical data transfer therebetween.

In an embodiment, the mobile communication module comprises a plurality of on-board optical transceivers and the ground communication module comprises a plurality of ground optical transceivers, each one the plurality of on-board optical transceivers being optically connectable to a corresponding one of the ground optical transceivers to allow optical data transfer, with each combination of on-board optical transceiver and ground optical transceiver operating at a specific wavelength being different for each combination.

In an embodiment, each on-board optical transceiver and ground optical transceiver includes a signal processor, an optical transmitter and an optical receiver together defining a single optical stream.

In an embodiment, the mobile storage unit is configured to receive and store the on-board commercial vehicle data until a threshold quantity of data relative to a cluster category is reached and to generate a cluster of on-board commercial vehicle data relative to the corresponding cluster category, once the threshold quantity of data relative to the corresponding cluster category has been received, the cluster of on-board commercial vehicle data being stored in the mobile storage unit of the mobile data storage and exchange unit.

In an embodiment, the mobile storage unit is partitioned into a temporary storage partition storing the on-board data until the threshold quantity of data relative to the cluster category is reached and a cluster storage partition storing the generated cluster of on-board data.

In an embodiment, the system further comprises a vehicle virtual image generated and stored in the ground data repository, the vehicle virtual image being a data-mirror-image of the entirety of the on-board data generated by the commercial vehicle.

In accordance with another general aspect, there is also provided a method for performing communication and storage of on-board commercial vehicle data. The method comprises the steps of: collecting on-board data commercial vehicle from the embarked systems of the commercial vehicle using a conventional on-board data communication network; accumulating and storing the received on-board data in a memory of a mobile data storage and exchange unit of the commercial vehicle at a data input speed limited by a network speed of the on-board data communication network; transferring the on-board commercial vehicle data from the mobile data storage and exchange unit to a ground data storage and exchange unit at a data transfer speed greater than the data input speed; and transferring the data from the ground data storage and exchange unit to a ground storage repository using a ground conventional data communication network.

In an embodiment, the step of accumulating and storing the received on-board commercial vehicle data in the memory of the mobile data storage and exchange unit of the commercial vehicle at the data input speed comprises accumulating and storing the received on-board commercial vehicle data in the memory of the mobile data storage and exchange unit of the commercial vehicle at maximal speed of about 100 Mbps.

In an embodiment, the step of transferring the on-board commercial vehicle data from the mobile data storage and exchange unit to the ground data storage and exchange unit at the data transfer speed greater than the data input speed comprises transferring the on-board commercial vehicle data from the mobile data storage and exchange unit to a ground data storage and exchange unit at a data transfer speed of at least about 1 Gbps.

In an embodiment, the step of transferring the on-board commercial vehicle data from the mobile data storage and exchange unit to the ground data storage and exchange unit includes establishing an optical contact between the mobile data storage and exchange unit and the ground data storage and exchange unit and using an optical signal to perform batch transfer of the on-board commercial vehicle data therebetween.

In an embodiment, the step of accumulating and storing the received on-board commercial vehicle data in the memory of the mobile data storage and exchange unit of the commercial vehicle comprises generating a cluster of on-board data relative to a corresponding cluster category and storing the cluster of on-board data, once a threshold quantity of on-board data relative to the corresponding cluster category has been received and stored on a memory of the mobile data storage and exchange unit of the commercial vehicle.

In an embodiment, the step of transferring the on-board commercial vehicle data from the mobile data storage and exchange unit to the ground data storage and exchange unit comprises transferring each cluster of on-board data from the memory of the mobile data storage and exchange unit to a memory of the ground data storage and exchange unit.

In an embodiment, the method further comprises the step of generating and updating a vehicle virtual image stored in a ground data repository.

In accordance with another general aspect, there is further provided an optical communication system for communication of commercial vehicle data. The optical communication system comprising: a mobile data storage and exchange unit having a mobile storage unit for storing on-board commercial vehicle data generated by at least one embarked system of the commercial vehicle; a ground data storage and exchange unit having a ground data storage unit for storing on-board data received from the mobile storage unit; a plurality of on-board optical transceivers included in the mobile data storage and exchange unit; and a plurality of ground optical transceivers included in the mobile data storage and exchange unit and each being optically connectable to a corresponding one of the plurality of on-board optical transceivers to allow optical data transfer therebetween, each combination of on-board optical transceiver and ground optical transceiver operating at a specific wavelength being different for each combination and being operable simultaneously with one another.

In an embodiment, each one of the plurality of on-board optical transceiver and the plurality of ground optical transceiver include a signal processor, an optical transmitter and an optical receiver together defining a single optical stream.

### BRIEF DESCRIPTION OF THE DRAWINGS

Other objects, advantages and features will become more apparent upon reading the following non-restrictive description of embodiments thereof, given for the purpose of exemplification only, with reference to the accompanying drawings in which:

FIG. 1 is a schematic representation of a general view of the system for communication and storage of commercial vehicle data in accordance with an embodiment.

FIG. 2 is another a schematic representation of the system for communication and storage of commercial vehicle data shown in FIG. 1, showing additional details.

FIG. 3 is a schematic representation a data storage and exchange unit in accordance with an embodiment.

FIG. 4 is a schematic representation of an optical communication system of the system for communication and storage of commercial vehicle data of FIG. 1.

FIG. 5 is another schematic representation of the system for communication and storage of commercial vehicle data shown in FIG. 1, showing the virtual vehicle image.

FIG. 6 is a schematic representation of a Protocol Data Unit format of the system for communication and storage of commercial vehicle data shown in FIG. 1.

### DETAILED DESCRIPTION

In the following description, the same numerical references refer to similar elements. The embodiments, configurations, exemplary components mentioned and/or dimensions shown in the figures or described in the present description are embodiments only, given solely for exemplification purposes.

Moreover, although the embodiments of the system for storage and communication of on-board commercial vehicle data and corresponding parts thereof consist of certain components as explained and illustrated herein, not all of these components are essential and thus should not be taken in their restrictive sense. It is to be understood, as also apparent to a person skilled in the art, that other suitable components and cooperation thereinbetween, as well as other suitable geometrical configurations, may be used for the system for communication and storage of commercial vehicle data, as will be briefly explained herein and as can be easily inferred herefrom by a person skilled in the art.

Moreover, although the associated method includes steps as explained and illustrated herein, not all of these steps are essential and thus should not be taken in their restrictive sense. It will be appreciated that the steps of the method for communication and storage of commercial vehicle data described herein may be performed in the described order, or in any suitable order.

To provide a more concise description, some of the quantitative and qualitative expressions given herein may be qualified with the terms “about” and “substantially”. It is understood that whether the terms “about” and “substantially” are used explicitly or not, every quantity or qualification given herein is meant to refer to an actual given value or qualification, and it is also meant to refer to the approximation to such given value or qualification that would reasonably be inferred based on the ordinary skill in the art, including approximations due to the experimental and/or measurement conditions for such given value.

In the course of the present description, the term “conventional communication network” is used to refer to any network, which includes private and public networks, as well as publicly accessible networks of linked networks, possibly operated by various distinct parties, such as, for example and without being limitative, at least one of a personal area network (PAN), a local area network (LAN), a wireless local area network (WLAN), a wide area network (WAN), an enterprise private network (EPN), a virtual private network (VPN), a passive optical local area network (POLAN), etc., or a combination thereof. One skilled in the art will understand that the networks can be embodied using cable connection, satellite connection, cellular connection, etc., or a combination thereof. The network(s) used for the conventional communication networks are designed and configured to allow the required security level for the secure transfer of the data between the associated data sources or data repositories.

Moreover, the term “optical wireless communication” (OWC) is used to refer to optical transmission in which guided light in the visible light (VL) spectrum (390-750 nm), the near infrared (IR) spectrum (750-1600 nm), or ultraviolet (UV) spectrum (100-390 nm) are used as propagation media in order to perform data transmission. For example and without being limitative OWC technologies include light communication (VLC) technology, light fidelity (LiFi) technology, optical camera communication technology, free-space optical communication (FSO) technology, or the like.

Furthermore, the term “short range wireless communication” is used herein to refer to data communication occurring using signals traveling of a communication distances in the range of between 1 cm and 100 m.

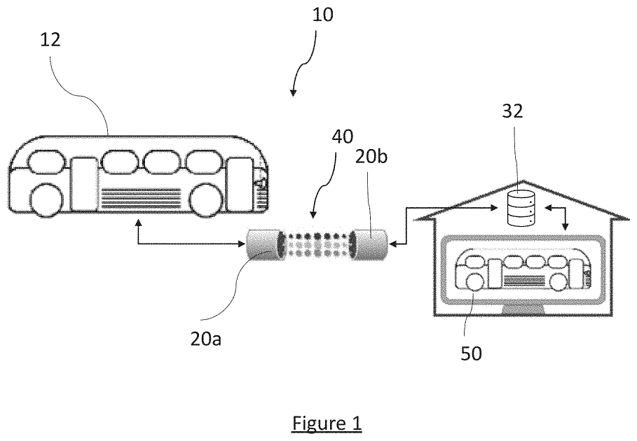

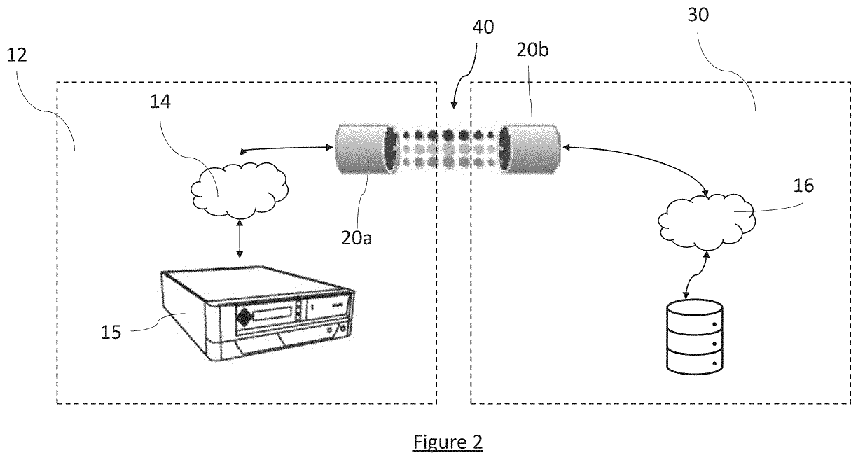

Referring generally to FIGS. 1 and 2, in accordance with one embodiment, there is provided a general view of the system 10 for communication and storage of on-board commercial vehicle data. As will be described in more details below, the system 10 is designed and configured to allow data transfers between a commercial vehicle 12 which is movable and a fixed ground data repository 32. The system 10 therefore allows the data generated on-board the vehicles 12 to be temporarily stored on-board the vehicle and subsequently be downloaded in batch to the fixed ground data repository 32 for the data to be processed by computers (or computing devices) associated therewith, using currently available processing technologies such as, for example and without being limitative, artificial intelligence (AI) or other machine learning algorithms, to analyze and interpret the data gathered by the different on-board devices, instruments, systems and/or components.

In the embodiment shown, the fixed ground data repository 32 is located at an operation control center (OCC) 30 having computers (or computing devices) for performing the processing of the data. One skilled in the art will understand that, in an alternative embodiment (not shown), the ground data repository 32 could be outside of the OCC 30 while being in constant data communication with the computer(s), through a constantly activated data communication network. In another alternative embodiment, the ground data repository 32 could be located in any other infrastructure or environment including computer(s) or computing devices for processing the data, or being in constant data communication therewith.

For example and without being limitative, in an embodiment, the commercial vehicle 12 can be any vehicle which is used in commercial operations such as freight transport, passenger transport or the like and can refer to vehicles such as trucks, busses, railcars, boats, planes, etc. In the course of the present description, only one vehicle will generally be described when referring to the system 10. One skilled in the art will, however, understand that numerous vehicles 12 can be equipped with components of the system 10. In an embodiment, access to the on-board data of multiple vehicles 12 can be performed. The reference to the single commercial vehicle 12 is used herein for ease of description, as it will easily be understood that similar features and components are used by each one of the multiple vehicles 12 using the system 10 described herein.

As mentioned above, the on-board data can include any type of data the commercial vehicle 12 can be configured to generate and/or collect using on-board devices, instruments, systems and/or components, such as, for example and without being limitative, system health and diagnostic data, geo-location data, passenger information data, fare collection data, telemetry data, automatic passenger counting data, media and entertainment data, video surveillance data, audio data, analytics data, diagnostic data, event data, incident/alarm data, etc. It will also be understood that the on-board data can include all data generated on-board the commercial vehicle 12, including core data and metadata.

For example and without being limitative, the on-board data can be generated by a plurality of embarked systems 15 of the associated commercial vehicle 12, with each one of the embarked systems 15 monitoring a specific aspect relative to the vehicle 12 and generating the associated on-board data. For example and without being limitative, the embarked systems 15 can include vehicle power status system, heating and air conditioning system, passenger door system, lighting system, telemetry system, CAD-AVL system, on-board electronic system, fare collection system, CCTV surveillance system, passenger information system, passenger entertainment system, driver behavior supervision system, advertising system, etc.

In an embodiment, the OCC 30 is located on the ground and has a fixed computing infrastructure. It is configured to store and process the data generated on-board the commercial vehicle 12 using known computing devices and infrastructures. In an embodiment, the OCC 30 can also be configured to monitor the status (or condition) of the embarked systems 15 installed on the commercial vehicle 12, such that the OCC 30 can determine whether update and/or upgrades of the firmware of one or more of the embarked systems 15 is/are required. When such updates and/or upgrades of the firmware is/are required, the data can be transferred using the system 10 to upload update and/or upgrade data to the vehicle 12.

As will be described in more details below, in an embodiment, the system 10 includes a combination of a mobile data storage and exchange unit 20a (or data capacitor) located on-board the commercial vehicle 12 and at least one ground data storage and exchange unit 20b (or data capacitor) located at a fixed location on the ground, for example at a site where the commercial vehicles 12 are typically immobilized for time periods (e.g. yards, depots, terminals, traffic lights, etc.). The mobile data storage and exchange unit 20a is in data communication with the embarked systems 15, through a conventional data communication network (or on-board conventional data communication network 14). The mobile data storage and exchange unit 20a is also in data communication with the ground data repository 32 through a conventional data communication network (or ground conventional data communication network 16).

The system 10 is configured to allow the transfer of data between the mobile data storage and exchange unit 20a and the ground data storage and exchange unit 20b at a high throughput (e.g. data transfer speeds of at least about 1 Gbps and up to about 10 Gbps). In an embodiment and as will also be described in more details below, the system 10 is configured to allow the transfer of data between the mobile data storage and exchange unit 20a and the ground data storage and exchange unit 20b using an optical communication system 40 using OWC technology capable of performing high-speed data transfers (e.g. at speed that can reach or exceed about 10 Gbps). Using the optical communication system 40, the data can be transferred between the mobile data storage and exchange unit 20a and the ground data storage and exchange unit 20b, when the two units 20a, 20b are sufficiently close and aligned to transfer data using OWC technologies. One skilled in the art will understand that the mobile data storage and exchange unit 20a can transfer data to different ground data storage and exchange unit 20b positioned at different locations on the ground and each connected to the ground data repository 32 over a network, for data transfer between the vehicle 12 and the ground data repository 32 ultimately receiving and storing the data.

As will also be described in more details below, in an embodiment the system 10 allows virtual vehicle image 50 of each commercial vehicle 12 using the system 10 to be generated and stored. The virtual vehicle image 50 allows substantially immediate access to on-board data of the specific corresponding commercial vehicle 12 without any delays caused by access or connectivity with the vehicle 12.

### Data Storage and Exchange Units (Data Capacitors)

Still referring to FIGS. 1 and 2, as mentioned above, the system 10 includes a mobile data storage and exchange unit 20a (or mobile data capacitor) installed on-board each commercial vehicle 12 and at least one ground data storage and exchange unit 20b (or ground data capacitor) located at a fixed location on the ground. As mentioned above in an embodiment, the ground data storage and exchange unit 20b are positioned at sites where the commercial vehicles 12 are typically immobilized for time periods (e.g. in yards, in vehicle depots, at terminals, proximate to traffic lights, etc.) such that the mobile data storage and exchange unit 20a and ground data storage and exchange unit 20b remain within a distance allowing short range wireless communication therebetween, for a time period.

As will be better understood in view of the description below, the mobile data storage and exchange unit 20a can receive and store data and subsequently perform data transfer in batch towards any of the ground data storage and exchange unit 20b, when the mobile data storage and exchange unit 20a and the ground data storage and exchange unit 20b are positioned to allow data transfer therebetween.

Analogously to electrical capacitors, the mobile data storage and exchange unit 20a and the ground data storage and exchange unit 20b are devices configured to allow large amounts of data to be accumulated (i.e. large quantity of data (e.g. more than 100 Gigabytes) to be received thereby and stored thereon) for the subsequent transfer of the data in batch. The mobile data storage and exchange unit 20a and the ground data storage and exchange unit 20b therefore allow data to be accumulated over time, at a data input speed which is often limited by the speed of the on-board conventional data communication network (e.g. 100 Mbps) and to be transferred to the ground data storage and exchange unit 20b at a transfer speed that is much greater than the data input speed (e.g. over about 1 Gbps and up to about 10 Gbps). In other words, the mobile data storage and exchange unit 20a and the ground data storage and exchange unit 20b allow a very high data throughput therebetween, such that a large quantity of data stored on the mobile data storage and exchange unit 20a can be transferred in batch to a corresponding ground data storage and exchange unit 20b, independently of the speed at which the data is initially accumulated into the mobile data storage and exchange unit 20a. Subsequently the data can be transferred from the ground data storage and exchange unit 20b to the ground data repository 32, using the ground conventional data communication network 16, independently of the network speed thereof (which can be slower than the transfer speed between the mobile data storage and exchange unit 20a and the ground data storage and exchange unit 20b).

In the course of the present description, the term “ground data repository” is used to refer to any element or structure capable of storing data, such as a central database or a plurality of distributed databases.

As previously mentioned, the mobile data storage and exchange unit 20a allows accumulation of data at conventional on-board network speeds (i.e. using conventional data communication network 14 for on-board vehicle data communication) and subsequent data transmission towards a corresponding ground data storage and exchange unit 20b using a communication system having a high throughput. The ground data storage and exchange unit 20b, in turn, allows the transfer of data accumulated therein towards the ground data repository 32, at conventional ground network speeds (i.e. using conventional data communication networks 16 available on the ground). For example and without being limitative, in an embodiment, the conventional data communication network 14 for on-board vehicle data communication allows network speed of up to about 100 Mbps, while the conventional data communication network 16 available on the ground generally offer network speed of up to about 1 Gbps. In contrast, the optical communication system 40 can allow a data transfer speed exceeding about 10 Gbps.

In view of the above, the combination of the mobile data storage and exchange unit 20a and the ground data storage and exchange unit 20b maximizes the data transfer speed between the commercial vehicle 12 and a fixed terminal (i.e. minimizes the time period required to allow the transfer of data between the commercial vehicle 12 and the fixed ground data storage and exchange unit 20b), while still allowing conventional communication infrastructures to be used to accumulate data into the mobile data storage and exchange unit 20a and to subsequently transfer the data from the ground data storage and exchange unit 20b to the ground data repository 32.

In an embodiment, the communication system for high throughput between the mobile data storage and exchange unit 20a and the ground data storage and exchange unit 20b is a bidirectional communication system, which also allows data to be transferred from the ground data storage and exchange unit 20b to the mobile data storage and exchange unit 20a. In an embodiment, the communication system for high throughput between the mobile data storage and exchange unit 20a and the ground data storage and exchange unit 20b allows full-duplex communication.

In view of the above, it will be understood that the reverse flow of data is also possible where data is accumulated in the ground data storage and exchange unit 20b and transferred to the mobile data storage and exchange unit 20a, for example to upload data required on-board, for example in order to install firmware upgrades/updates, security updates, etc. on the embarked systems 15 on-board the commercial vehicle 12. In an embodiment, the data required on-board to install firmware upgrades/updates, security updates, etc. can be generated at the OCC 30 and stored on the ground data storage and exchange unit 20b for subsequent transfer in batch to the mobile data storage and exchange unit 20a.

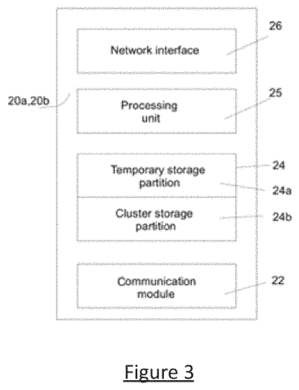

Referring to FIG. 3, each one of the mobile data storage and exchange unit 20a and the ground data storage and exchange unit 20b includes a network interface 26, a storage unit 24, a processing unit 25 and a high throughput wireless communication module 22.

The processing unit 25 (or processor) is the hardware component of the data storage and exchange units 20a, 20b allowing execution of instructions stored in a memory of the data storage and exchange units 20a, 20b for performing computer implemented tasks of the data storage and exchange units 20a, 20b or the components thereof.

The network interface 26 is a component including the hardware and software required to physically connect the corresponding one of the mobile data storage and exchange unit 20a and ground data storage and exchange unit 20b to the corresponding conventional data communication network 14, 16 and to process the low-level network information therefrom to perform the data transfer. For example and without being limitative, in an embodiment, the network interface 26 can include a connector and the associated circuitry to allow a wired or a wireless transmission and reception of data, for data connection of the data storage and exchange units 20a, 20b with at least one of an ethernet network, a token-ring network, a Fiber Distributed Data Interface (FDDI) network, a Synchronous Optical Network (SONET), a Wi-Fi network, a Bluetooth network, or the like. One skilled in the art will understand that the above examples are non-limitative and that the network interface 26, therefore allows the data storage and exchange units 20a, 20b to be independent of the physical conventional data communication networks 14, 16 (i.e. the data storage and exchange units 20a, 20b can be in data communication with any type of physical conventional data communication networks 14, 16).

The storage unit 24 is a component allowing the persistent storage of data thereon. In order to allow the required throughput of the data storage and exchange units 20a, 20b, the storage unit 24 offers a fast access time and a low latency. Therefore, in an embodiment, the storage unit 24 comprises a solid-state drive (SSD) using flash memory, where integrated circuit assemblies are used for storing the data persistently. One skilled in the art will understand that, in alternative embodiments, an SSD using other memory types, such as NAND flash could also be used. In other alternative embodiments, other types of storage devices allowing sufficiently fast access time and low latency, such as a Solid-State Hybrid Drive (SSHD) could also be used.

In an embodiment, the storage unit 24 is partitioned specifically to allow efficient and fast data transfers between the corresponding data storage and exchange units 20a, 20b. For example and without being limitative, in an embodiment, the storage unit 24 is partitioned to include a temporary storage partition 24a and a cluster storage partition 24b. The storage unit 24 of the mobile data storage and exchange unit 20a is configured to store the on-board data from the embarked systems 15 on the temporary storage partition 24a until a threshold quantity of data relative to a cluster category (or slice category) is received and stored thereon. The processing unit 25 of the mobile data storage and exchange unit 20a is configured to generate a cluster of data (or data slice) of on-board data relative to the corresponding cluster category (or slice category), once the threshold quantity of data relative to the corresponding cluster category (or slice category) has been received and stored on the temporary storage partition 24a. Once a cluster (or slice) of on-board data has been generated, the cluster (or slice) is stored on the cluster storage partition 24b, awaiting transfer thereof.

When data transfers can occur between a mobile data storage and exchange unit 20a and a ground data storage and exchange unit 20b, the clusters (or slices) of on-board data are transferred from the cluster storage partition 24b of the mobile data storage and exchange unit 20a to the cluster storage partition 24b of the ground data storage and exchange unit 20b.

In an embodiment, the processing unit 25 of the ground data storage and exchange unit 20b can subsequently reassemble all the data packets from the clusters (or slices) of on-board data in the proper sequence and store the data packets in the temporary storage partition 24a of the ground data storage and exchange unit 20b, for subsequent transfer of the data packets to the ground data repository 32, through the ground conventional data communication network 16.

In an embodiment, once the clusters (or slices) of on-board data are transferred from the cluster storage partition 24b of the mobile data storage and exchange unit 20a to the cluster storage partition 24b of the ground data storage and exchange unit 20b, the data is erased from the cluster storage partition 24b of the mobile data storage and exchange unit 20a in order to clear and maximize the available storage space of the storage unit 24 of the mobile data storage and exchange unit 20a.

Using the above described partitioning, the storage unit 24 of the mobile data storage and exchange unit 20a allows real time (or near-real time) storage of on-board data from the embarked systems 15 onto the storage unit 24 and subsequent efficient and fast data transfer between data storage and exchange units 20a, 20b.

In an embodiment, the on-board data received from the embarked systems 15 of the commercial vehicle 12 is stored on the temporary storage partition 24a of the mobile data storage and exchange unit 20a as received from the embarked systems 15 (the packets are stored as is, when received at the network interface 26 from the on-board conventional data communication network 14) and is not further formatted, bundled, packaged, etc. In such an embodiment, the processing unit 25 rather formats the on-board data in clusters of data (or data slices) only once a threshold quantity of data relative to a cluster category is received, in order to allow subsequent efficient and fast data transfer.

In an alternative embodiment, the processing unit 25 can perform pre-processing of the on-board data received from the embarked systems 15 of the commercial vehicle 12 before storing the processed data on the temporary storage partition 24a of the mobile data storage and exchange unit 20a. Pre-processing of the data by the processing unit 25 can for example be performed to validate, sort, summarize, aggregate, analyze and/or classify the raw on-board data received from the embarked systems 15 in order to generate meaningful information therefrom. In an embodiment, the generated information can be used to generate the clusters of data (or data slices) once a threshold quantity of information relative to a cluster category is received, in order to allow the subsequent efficient and fast data transfer.

In an embodiment, a combination of information generated by processing of the raw on-board data received from the embarked systems 15 by the processing unit 25 and raw on-board data received from the embarked systems 15 can be stored on the mobile data storage and exchange unit 20a and downloaded to the ground data storage and exchange unit 20b.

Using the above described partitioning and data packaging process, the storage unit 24 of the mobile data storage and exchange unit 20a allows real time (or near-real time) storage of on-board data from the embarked systems 15 onto the storage unit 24 and subsequent efficient and fast data transfer between data storage and exchange units 20a, 20b.

In an embodiment, the clusters (or slices) are bundled into a single file for transfer thereof (in accordance with the Protocol Data Unit (PDU) format which will be described in more details below). More details regarding the clusters (or slices), their uses and the different cluster categories (or slice categories) handled by the storage unit 24 will be described below when discussing the virtual vehicle image 50.

One skilled in the art will understand that, in an alternative embodiment (not shown), the storage unit 24 could include a plurality of distinct storage units 24 (or storage devices) in data communication with one another rather than a single partitioned storage unit 24.

The wireless communication module 22 is the component including the required hardware and software to allow the high throughput communication between corresponding ones of the data storage and exchange units 20a, 20b positioned to allow data transfers (i.e. when the mobile data storage and exchange unit 20a and the corresponding ground data storage and exchange unit 20b are positioned sufficiently close and/or within the required field of view to allow data transfers), for example using the optical communication system 40 described in more details below.

### Optical Communication System

In the embodiment shown, the wireless communication module 22 is an optical wireless communication module, using an optical communication system 40. The optical communication system 40 is a bidirectional data communication system using OWC technology to perform transmission of data over the visible light spectrum (390-750 nm) and the near infrared spectrum (750-1600 nm), between the data storage and exchange units 20a, 20b. For example and without being limitative, in an embodiment, the OWC used by the optical communication system 40 can be a Li-Fi technology or other type of VLC technology which allow short range wireless optical communication between the data storage and exchange units 20a, 20b when the data storage and exchange units 20a, 20b are within one another's field of view.

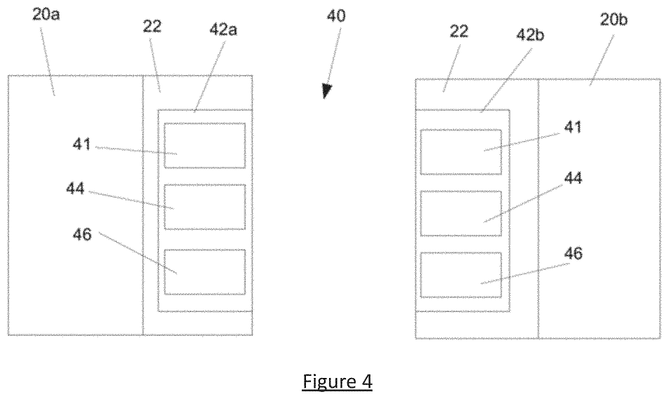

Referring to FIG. 4, in an embodiment, the optical communication system 40 includes at least one optical transceiver 42 included in the wireless communication module 22 of each data storage and exchange units 20a, 20b. Each optical transceiver 42 is composed of a signal processor 41, an optical transmitter 44 and an optical receiver 46 together defining a single optical stream.

The signal processor 41 uses signal processing technology to convert the binary data into light signals which can be emitted by the optical transmitter 44 and to convert the signal received from the optical receiver 46 back to binary data.

In an embodiment, the optical transmitter 44 includes a light-emitting diode (LED) where the intensity of the emitted light can be modulated (i.e. varied by being dipped and dimmed, up and down) at high speed, to emit the optical signal having data embedded in the light beam. In an alternative embodiment, the optical transmitter 44 can rather include a laser transmitter where the data is embedded in the laser beam. One skilled in the art will understand that, in other alternative embodiments, other transmitter types or combination of a plurality of optical transmitter types could also be used.

In an embodiment, the optical receiver 46 is a photodetector receiving the light beam from the optical transmitter 44 and converting the sensed light into current. The signal processor 41 can therefore receive the current signal from the optical receiver 46 and convert the received current signals into data to be stored in the storage unit 24 of the corresponding data storage and exchange unit 20a, 20b.

In an embodiment, the optical communication system 40 can include a single optical transceiver 42 included in the wireless communication module 22 of each data storage and exchange unit 20a, 20b, which allow the bidirectional communication of data.

In an alternative embodiment, in order to increase the data throughput of the system 10, the optical communication system 40 can include multiple optical transceivers 42, operating in parallel and each operating at a specific wavelength, with each one of the multiple optical transceivers 42 operating at a different wavelength. The combination of the multiple optical transceivers 42 together define an aggregated optical link.

For example and without being limitative, in different embodiments the optical communication system 40 could include 2, 3 or 4 optical transceivers 42 in the wireless communication module 22 of each data storage and exchange unit 20a, 20b, each emitting a guided optical beam oriented to prevent interference therebetween. In such embodiments, each file formatted and ready to be transmitted by a data storage and exchange unit 20a, 20b (i.e. each file containing the data clusters (or data slices) ready for transfer can be segmented into a corresponding number of smaller files (i.e. the number of files corresponding to the number of optical transceivers 42)) for parallel (or simultaneous) transmission of the segmented files. In an alternative embodiment, each file formatted and ready to be transmitted by a data storage and exchange unit 20a, 20b (i.e. each file containing the data clusters (or data slices) ready for transfer can be communicated to a corresponding data storage and exchange unit 20a, 20b, with multiple files being transferred in parallel (or simultaneously). Such segmentation of the file(s) containing the data to be transferred (and parallel transmission of the smaller segmented file(s)) or the parallel transmission of multiple files, results in a decrease of the time period required to transfer the data (i.e. the effective aggregated transmission speed is substantially equal to approximately the sum of the speed of the individual optical transceivers 42 allowing data communication between two storage and exchange units 20a, 20b.

In view of the above, the optical communication system 40 includes an on-board optical transceiver 42a integrated in the wireless communication module 22 of each mobile data storage and exchange unit 20a and a ground optical transceiver 42b integrated in the wireless communication module 22 of each ground data storage and exchange unit 20b.

In an embodiment, the data transfer of the on-board data from a commercial vehicle 12 can be initiated (i.e. data can be transferred from a mobile data storage and exchange unit 20a and a corresponding ground data storage and exchange unit 20b) when the on-board optical transceiver 42a and the ground optical transceiver 42b are within a communication distance range of about 10 meter or less and within a field of view of about 60 degrees or less.

In an embodiment, the data transmitted optically between the on-board data transceiver 42a and the ground data transceiver 42b is encrypted to ensure security of the data being transferred. For example and without being limitative, in an embodiment, conventional encryption industry standards such, AES, 3DES, SHA-2 256-bit, 384-bit and 512-bit, RSA and IPSec can be used for encrypting the data being transferred.

The above described optical communication system 40 offers several advantages over data communication systems currently used for transferring data from a commercial vehicle 12, such as, without being limitative, a wider bandwidth channel, the ability to safely function in areas otherwise susceptible to electromagnetic interference, high data transfer speed, secure communication, data transmission with no loss of information, etc.

In an alternative embodiment, the wireless communication module 22 can be configured to allow a high throughput data communication between the corresponding ones of the data storage and exchange units 20a, 20b, using a technology different from OWC.

### Virtual Vehicle Image

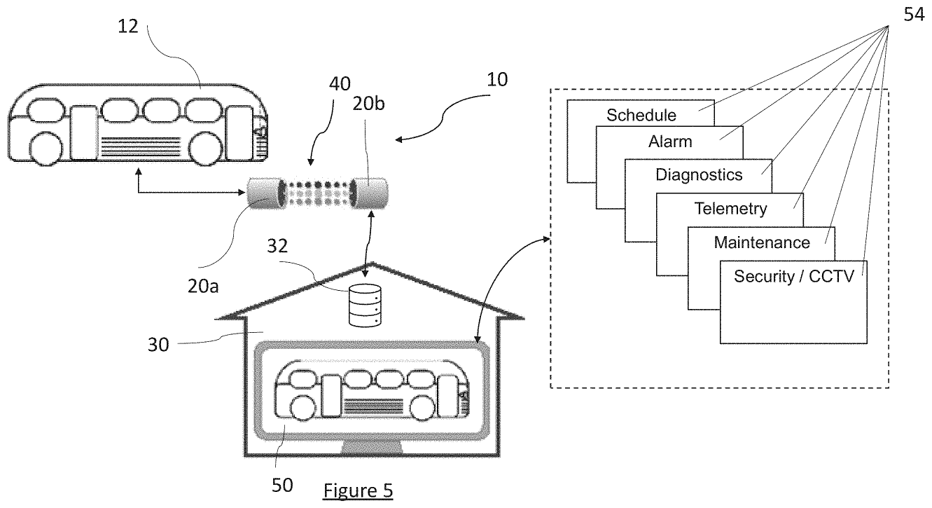

Now referring to FIG. 5, the above-described system 10 for storage and communication of on-board data, including the data storage and exchange units 20a, 20b and wireless communication module 22, for example allows generation and maintenance of a virtual vehicle image 50 of each one of the commercial vehicles 12 using the system 10 at the OCC 30.

The virtual vehicle image 50 is a digital twin (or data-mirror-image) of the entirety of the on-board data generated by a specific commercial vehicle 12. In an embodiment, the virtual vehicle image 50 is stored in the ground data repository 32, at the OCC 30. As mentioned above, one skilled in the art will, however, understand that, in an alternative embodiment, the virtual vehicle image 50 could be stored in a ground data repository 32 located on the ground and in permanent data communication with the OCC 30 (i.e. stored in a data repository in constant data communication with the OCC 30 via a high-speed network rather than directly at the OCC 30).

One skilled on the art will understand that the purpose of the virtual vehicle image 50 is therefore to relocate (or duplicate) the bulk of the on-board data from the commercial vehicle 12 in the ground data repository 32, where the data is easily accessible by the OCC 30 for query thereof. In order to do so, in an embodiment, the on-board data is therefore initially accumulated in the mobile data storage and exchange unit 20a and transferred on the ground to a corresponding ground data storage and exchange unit 20b, using the wireless communication module 22, when the optical transceiver 42b of a ground data storage and exchange unit 20b is within the required distance and field of view of the optical transceiver 42a of the mobile data storage and exchange unit 20a. In an embodiment, in order to allow the virtual vehicle image 50 to be as up to date as possible, the on-board data from the commercial vehicle 12 is transferred to the ground data repository 32 using multiple ground data storage and exchange units 20b acquiring data from the mobile data storage and exchange unit 20a (each connected to the ground data repository 32 using a ground conventional data communication network 16), with the multiple ground data storage and exchange units 20b being positioned throughout the service route of the commercial vehicle 12.

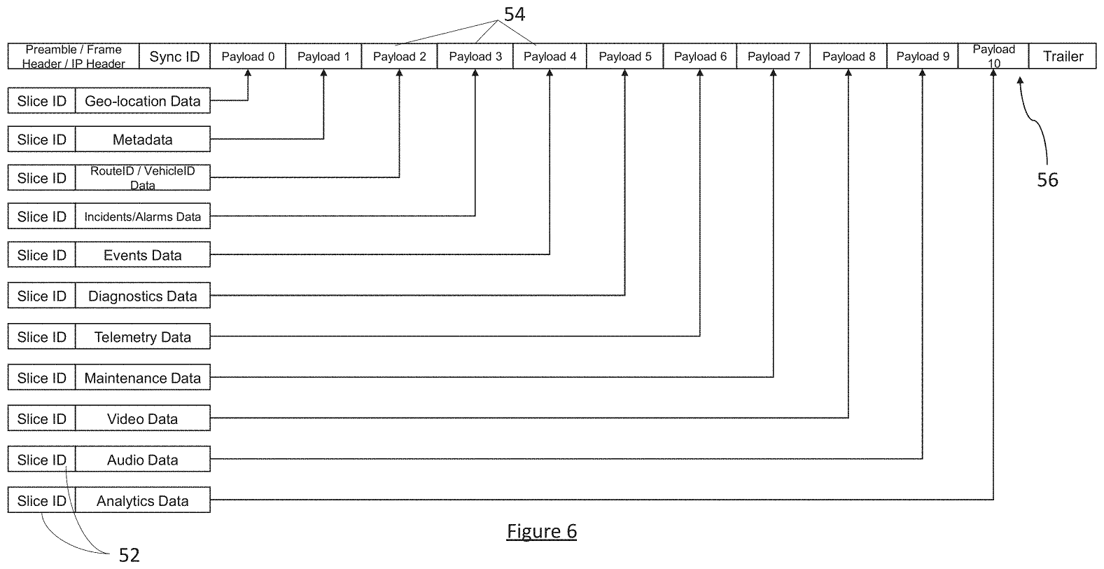

Referring to FIG. 6, in an embodiment, in order to allow the generation and repeated update of the virtual vehicle image 50, the on-board data from all on-board embarked systems 15 (or sub-systems) is initially gathered and is subsequently formatted in a PDU format allowing the on-board data from the different on-board embarked systems 15 to be synchronized to a common time base and subsequently be formatted to be included in a single file 56. In such an embodiment, this single file formatted in the PDU format is generated by the mobile data storage and exchange unit 20a and stored thereon for the subsequent transfer to a corresponding ground data storage and exchange unit 20b on the ground.

In an embodiment, the synchronization to the common time base is performed by the on-board controllers of each individual embarked system 15 receiving a time stamp at the time the on-board controllers generate a data output (e.g. by logging an event, triggering an alarm, etc.) The two elements of information (time stamp and output data) will be linked and transmitted to the mobile data storage and exchange unit 20a for further processing and storage in the mobile data storage and exchange unit 20a. For example and without being limitative, in an embodiment, the time stamps are established based on one of the on-board GPS server or a Network Time Protocol (NTP) server available to the system 10.

In the embodiment shown, in the PDU format, each sub-system is assigned a specific cluster type 52 (i.e. a specific slice type identified as SliceID in the Figure), in order to indicate the type of data associated with the specific cluster 54 (or slice). In an embodiment, in order to minimize the amount of data to transfer between the mobile data storage and exchange unit 20a and the ground to a corresponding ground data storage and exchange unit 20b (i.e. to minimize the size of the file 56 containing the clusters of data), each cluster of data 54 (or slice) includes a specific field (not shown) to indicate if the data within the cluster 54 is compressed or not by the mobile data storage and exchange unit 20a. For example, and without being limitative, telemetry data usually consists of large text files which can be easily compressed, while video data is usually already compressed and will not be further compressed by the mobile data storage and exchange unit 20a.

Hence, as mentioned above, in an embodiment, the processing unit 25 of the mobile data storage and exchange unit 20a is therefore configured to generate the clusters of data 54 (or data slice) of on-board data relative to the corresponding cluster categories 52 (or slice categories), once the threshold quantity of data relative to the corresponding cluster category 52 (or slice category) has been received and stored on the temporary storage partition 24a. Once a cluster (or slice) of on-board data 54 has been generated, the cluster (or slice) is stored in the cluster storage partition 24b and the clusters are grouped in a single file 56 according to the PDU format for subsequent transfer of the file 56 to a ground data storage and exchange unit 20b.

Once a file is transmitted and received by the ground data storage and exchange unit 20b, and transferred to the ground data repository 32 via the ground conventional data communication network 16, in an embodiment, each data cluster (or slice) is extracted and stored into a dedicated file associated with the type of data the cluster of data represents, for subsequent update of the virtual vehicle image 50. In such an embodiment, the on-board data received at the ground data repository 32 is therefore compatible with existing workstations using known software and data format, for subsequent analysis of the data defined by the virtual vehicle image 50. In an alternative embodiment, no further data manipulation is performed on the PDU formatted file received at the ground data repository 32 and used to update of the virtual vehicle image 50. In such an alternative embodiment, the workstation of the OCC 30 is configured to read and analyze the file in the PDU format.

The use of the virtual vehicle image 50 overcomes issues relating to accessibility of data (and the associated delays associated to querying data located on a mobile vehicle which is often disconnected from ground data communication network for long time periods) by creating and repeatedly updating a complete vehicle image (identified herein as the virtual vehicle image 50) at the ground data repository 32, which allow any query to be immediately processed as a result of a copy of the on-board data being stored locally. In other words, the virtual vehicle image 50 overcomes the necessity of the physical availability of the commercial vehicle 12 for data communication in order to query the on-board data, the on-board data being transferred to the ground data repository 32 and accessible by the OCC 30, ahead of time via the virtual vehicle image 50.

In view of the above, in contrast to known prior art systems which required data communication with the commercial vehicle 12 to perform a query, the generation of the virtual vehicle image 50 allows immediate data queries to be performed on the on-board data from the embarked systems 15 of the corresponding commercial vehicle 12, without the otherwise required delays for locating and/or connecting to the commercial vehicle 12 for acquiring and querying the relevant data.

One skilled in the art will understand that queries for on-board data are created on a continuous basis in order to analyze situations. For example and without being limitative, typical queries include: scheduled/ad hoc data queries, telemetry logs data queries, incident logs data queries, alarm logs data queries, police/security data queries, maintenance information data queries, etc. Hence, in view of the above, the virtual vehicle image 50 allow such continuous query on data having a greater availability than if it is stored on-board the commercial vehicle 12.

The storage of the on-board data at the ground data repository 32 accessible by the OCC 30 also offers other advantageous factors such as lower cost, greater storage capacity, greater security, greater reliability and expandability of the ground storage than the mobile storage. Moreover, in an embodiment, the virtual vehicle image 50 could even be transferred onto the cloud for backup and/or analysis.

### Method

The system for storage and communication of commercial vehicle data having been described in detail above, the corresponding method for performing communication and storage of commercial vehicle data will now be described in more details below.

In an embodiment, the method includes the initial steps of collecting on-board data generated by embarked systems of the commercial vehicle received from a conventional on-board data communication network (and at conventional on-board network speed, such as, for example at about 100 Mbps) and accumulating and storing the received on-board data in a memory of a mobile data storage and exchange unit of the commercial vehicle.

The method includes the subsequent step of transferring the on-board data from the mobile data storage and exchange unit to a ground data storage and exchange unit, using a high throughput communication system allowing high data transfer speed (such as over about 1 Gbps). In an embodiment, this step of the method includes, transferring the on-board data from the mobile data storage and exchange unit to a ground data storage and exchange unit, using an optical communication system using OWC technology.

Finally, the method includes the step of transferring the data from the ground data storage and exchange unit to the ground data repository using a ground conventional data communication network (and at ground conventional data communication network speed).

In an embodiment, the step of transferring the on-board data from the mobile data storage and exchange unit to a ground data storage and exchange unit, using an optical communication system, includes establishing an optical contact between the mobile data storage and exchange unit and the ground data storage and exchange unit and transferring the data in batch using an optical signal therebetween.

In an embodiment, the step of accumulating and storing the received on-board data in a memory of the mobile data storage and exchange unit of the commercial vehicle further includes the step of generating a cluster of data (or data slice) of on-board data relative to a corresponding cluster category (or slice category) and storing the cluster of data, once a threshold quantity of on-board data relative to the corresponding cluster category (or slice category) has been received and stored on a memory of the mobile data storage and exchange unit of the commercial vehicle.

In such an embodiment, the step of transferring the on-board data from the mobile data storage and exchange unit to a ground data storage and exchange unit includes the step of transferring each cluster of data from the memory of the mobile data storage and exchange unit to a memory of the ground data storage and exchange unit.

In an embodiment, the step of transferring the on-board data from the mobile data storage and exchange unit to a ground data storage and exchange unit, using an optical communication system, includes establishing an optical contact between the mobile data storage and exchange unit and the ground data storage and exchange unit, with the optical contact including multiple optical links operating at a different wavelength and operable in parallel, and transferring the data in batch using the plurality of optical links to transfer data simultaneously over the multiple optical links.

In an embodiment, the method further comprises the step of generating and updating a vehicle virtual image at the ground data repository for each commercial vehicle, using the on-board thereof received from the ground data storage and exchange unit.

One skilled in the art will understand that, in an embodiment, the method could also include the reverse steps, in order to allow upload of data to the commercial vehicle.

The skilled reader will readily recognize that steps of the method can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The embodiments are also intended to cover computers programmed to perform said steps of the above-described methods.

It should be appreciated by those skilled in the art that any block diagrams herein represent conceptual views of illustrative circuitry embodying the principles disclosed herein. Similarly, it will be appreciated that any flow charts and transmission diagrams, and the like, represent various processes which may be substantially represented in computer readable medium and so executed by a computer or processor, whether or not such computer or processor is explicitly shown.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention could be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A system for storage and communication of on-board commercial vehicle data generated on-board a movable commercial vehicle, the system comprising:
at least one embarked system installed on the commercial vehicle and generating the on-board commercial vehicle data;
an on-board data communication network; and
a mobile data storage and exchange unit installed on the movable commercial vehicle and being in data communication with the at least one embarked system via the on-board data communication network of the movable commercial vehicle, to receive the on-board commercial vehicle data generated by the at least one embarked system, the mobile data storage and exchange unit comprising:
a mobile storage unit for storing the on-board commercial vehicle data, the on-board commercial vehicle data being received and stored at a data input speed limited by a network speed of the on-board data communication network; and
a wireless communication module allowing data transfer between the mobile data storage and exchange unit and a ground data storage and exchange unit, the wireless communication module having a data transfer speed greater than the data input speed and providing a high throughput data communication to perform batch transfer of the on-board commercial vehicle data stored on the mobile data storage and exchange unit to the ground data storage and exchange unit when the mobile data storage and exchange unit and the ground data storage and exchange unit are within a communication range.

2. The system of claim 1, wherein the maximal data input speed is about 100 Mbps and the minimal data transfer speed of the wireless communication module is about 1 Gbps.

3. (canceled)

4. The system of claim 1, wherein the wireless communication module comprises an optical wireless communication system comprising:
at least one on-board optical transceiver included in the mobile data storage and exchange unit; and
at least one ground optical transceiver included in the mobile data storage and exchange unit and optically connectable to the on-board optical transceiver to allow optical data transfer of the on-board commercial vehicle data between the mobile data storage and exchange unit and the ground data storage and exchange unit.

5. The system of claim 4, wherein the wireless communication module comprises:
a plurality of on-board optical transceivers included in the mobile data storage and exchange unit; and
a plurality of ground optical transceivers included in the mobile data storage and exchange unit and each being optically connectable to a corresponding one of the on-board optical transceivers to allow optical data transfer, each combination of on-board optical transceiver and ground optical transceiver operating at a specific wavelength being different for each combination;
each on-board optical transceiver and each ground optical transceiver including a signal processor, an optical transmitter and an optical receiver together defining a single optical stream.

6. (canceled)

7. The system of claim 1, further comprising:
a ground data repository;
a ground data communication network;
the ground data storage and exchange unit being in data communication with the ground data repository via the ground data communication network, to allow data transfer of the on-board commercial vehicle data received by the ground data storage and exchange unit to the ground data repository; and
a vehicle virtual image generated and stored in the ground data repository, the vehicle virtual image being a data-mirror-image of the entirety of the on-board commercial vehicle data generated by the commercial vehicle.

8. (canceled)

9. The system of claim 1, wherein the mobile storage unit is configured to receive and store the on-board commercial vehicle data until a threshold quantity of on-board commercial vehicle data relative to a cluster category is reached and to generate a cluster of on-board commercial vehicle data relative to the corresponding cluster category, once the threshold quantity of data relative to the corresponding cluster category has been received, the cluster of on-board commercial vehicle data being stored in the mobile storage unit of the mobile data storage and exchange unit, and wherein the mobile storage unit is partitioned into a temporary storage partition storing the on-board commercial vehicle data until the threshold quantity of data relative to the cluster category is reached and a cluster storage partition storing the generated cluster of on-board data.

10. (canceled)

11. A system for storage and communication of on-board commercial vehicle data between a movable commercial vehicle and a ground data repository, the system comprising:
at least one embarked system installed on the commercial vehicle and generating the on-board commercial vehicle data;
an on-board data communication network;
a ground data communication network;
a mobile data storage and exchange unit having a mobile storage unit for storing on-board commercial vehicle data, the mobile data storage and exchange unit being installed on the movable commercial vehicle and being in data communication with the at least one embarked system via the on-board data communication network of the movable commercial vehicle to receive and store the on-board commercial vehicle data generated by the at least one embarked system on the mobile storage unit, the on-board commercial vehicle data being received and stored at a data input speed limited by a network speed of the on-board data communication network;
a ground data storage and exchange unit in data communication with the ground data repository via the ground data communication network, the ground data storage and exchange unit having a ground storage unit and being communicatively connectable to the mobile data storage and exchange unit to allow data transfer between the mobile data storage and exchange unit and a ground data storage and exchange unit, the ground data storage and exchange unit and the mobile data storage and exchange unit being configured to perform data transfer therebetween at a data transfer speed greater than the data input speed to perform batch transfer of the on-board commercial vehicle data stored on the mobile data storage and exchange unit to the ground data storage and exchange unit when the mobile data storage and exchange unit and the ground data storage and exchange unit are within a communication distance.

12. The system of claim 11, wherein the maximal data input speed is about 100 Mbps and the minimal data transfer speed of the wireless communication module is about 1 Gbps.

13. (canceled)

14. The system of claim 11, wherein the mobile data storage and exchange unit comprises a mobile communication module including an on-board optical transceiver and the ground data storage and exchange unit comprises a ground communication module including a ground optical transceiver, the on-board optical transceiver being optically connectable to the ground optical transceiver for optical data transfer therebetween each on-board optical transceiver and ground optical transceiver include a signal processor, an optical transmitter and an optical receiver together defining a single optical stream.

15. The system of claim 14, wherein the mobile communication module comprises a plurality of on-board optical transceivers and the ground communication module comprises a plurality of ground optical transceivers, each one the plurality of on-board optical transceivers being optically connectable to a corresponding one of the ground optical transceivers to allow optical data transfer, with each combination of on-board optical transceiver and ground optical transceiver operating at a specific wavelength being different for each combination.

16. (canceled)

17. The system of claim 11, wherein the mobile storage unit is configured to receive and store the on-board commercial vehicle data until a threshold quantity of data relative to a cluster category is reached and to generate a cluster of on-board commercial vehicle data relative to the corresponding cluster category, once the threshold quantity of data relative to the corresponding cluster category has been received, the cluster of on-board commercial vehicle data being stored in the mobile storage unit of the mobile data storage and exchange unit, and wherein the mobile storage unit is partitioned into a temporary storage partition storing the on-board data until the threshold quantity of data relative to the cluster category is reached and a cluster storage partition storing the generated cluster of on-board data.

18. (canceled)

19. The system of claim 11, further comprising a vehicle virtual image generated and stored in the ground data repository, the vehicle virtual image being a data-mirror-image of the entirety of the on-board data generated by the commercial vehicle.

20. A method for performing communication and storage of on-board commercial vehicle data, the method comprising the steps of:
collecting on-board data commercial vehicle from the embarked systems of the commercial vehicle using a conventional on-board data communication network;
accumulating and storing the received on-board data in a memory of a mobile data storage and exchange unit of the commercial vehicle at a data input speed limited by a network speed of the on-board data communication network;
transferring the on-board commercial vehicle data from the mobile data storage and exchange unit to a ground data storage and exchange unit at a data transfer speed greater than the data input speed; and
transferring the data from the ground data storage and exchange unit to a ground storage repository using a ground conventional data communication network.

21. The method of claim 20, wherein the step of accumulating and storing the received on-board commercial vehicle data in the memory of the mobile data storage and exchange unit of the commercial vehicle at the data input speed comprises accumulating and storing the received on-board commercial vehicle data in the memory of the mobile data storage and exchange unit of the commercial vehicle at maximal speed of about 100 Mbps.

22. The method of claim 20, wherein the step of transferring the on-board commercial vehicle data from the mobile data storage and exchange unit to the ground data storage and exchange unit at the data transfer speed greater than the data input speed comprises transferring the on-board commercial vehicle data from the mobile data storage and exchange unit to a ground data storage and exchange unit at a data transfer speed of at least about 1 Gbps.

23. The method of claim 20, wherein the step of transferring the on-board commercial vehicle data from the mobile data storage and exchange unit to the ground data storage and exchange unit includes establishing an optical contact between the mobile data storage and exchange unit and the ground data storage and exchange unit and using an optical signal to perform batch transfer of the on-board commercial vehicle data therebetween.

24. The method of claim 20, wherein the step of accumulating and storing the received on-board commercial vehicle data in the memory of the mobile data storage and exchange unit of the commercial vehicle comprises generating a cluster of on-board data relative to a corresponding cluster category and storing the cluster of on-board data, once a threshold quantity of on-board data relative to the corresponding cluster category has been received and stored on a memory of the mobile data storage and exchange unit of the commercial vehicle, and wherein the step of transferring the on-board commercial vehicle data from the mobile data storage and exchange unit to the ground data storage and exchange unit comprises transferring each cluster of on-board data from the memory of the mobile data storage and exchange unit to a memory of the ground data storage and exchange unit.

25. (canceled)

26. The method of claim 20, wherein the method further comprises the step of generating and updating a vehicle virtual image stored in a ground data repository.

27. An optical communication system for communication of commercial vehicle data, the optical communication system comprising:
a mobile data storage and exchange unit having a mobile storage unit for storing on-board commercial vehicle data generated by at least one embarked system of the commercial vehicle;
a ground data storage and exchange unit having a ground data storage unit for storing on-board data received from the mobile storage unit;
a plurality of on-board optical transceivers included in the mobile data storage and exchange unit; and
a plurality of ground optical transceivers included in the mobile data storage and exchange unit and each being optically connectable to a corresponding one of the plurality of on-board optical transceivers to allow optical data transfer therebetween, each combination of on-board optical transceiver and ground optical transceiver operating at a specific wavelength being different for each combination and being operable simultaneously with one another.

28. The optical communication system of claim 27, wherein the each one of the plurality of on-board optical transceiver and the plurality of ground optical transceiver include a signal processor, an optical transmitter and an optical receiver together defining a single optical stream.
